(19) United States
(12) Patent Application Publication
(10) Pub. No.: US 2026/0021963 A1
(43) Pub. Date: Jan. 22, 2026

(54) CONTAINER HANDLING VEHICLE WITH MOTOR AT LOWER ELEVATION THAN FIRST AND SECOND LIFTING SHAFTS, A SYSTEM COMPRISING THE CONTAINER HANDLING VEHICLE, AND METHOD OF DRIVING THE FIRST AND SECOND LIFTING SHAFTS

(71) Applicant: AutoStore Technology AS, Nedre Vats (NO)

(72) Inventors: Trond Austrheim, Etne (NO); Ivar Fjeldheim, Haugesund (NO)

(21) Appl. No.: 18/875,767

(22) PCT Filed: Jun. 23, 2023
(86) PCT No.: PCT/EP2023/067078

§ 371 Date: Dec. 17, 2024

(30) Foreign Application Priority Data
Jun. 29, 2022 (NO) 20220739

(51) Int. Cl. B65G 1/04; B65G 1/06; B66C 1/10

(52) U.S. Cl. CPC B65G 1/0464; B65G 1/065; B66C 1/101

(57) ABSTRACT

The invention relates to a container handling vehicle for moving storage containers stacked in stacks within an automated storage and retrieval system, wherein the container handling vehicle is configured to move on a rail system above storage columns, wherein the container handling vehicle comprises a lifting assembly (60) which comprises a first lifting shaft (25) and a second lifting shaft (26) supported in an upper portion of the vehicle and a motor (13) for driving a drive belt (20) for rotating the first lifting shaft (25) and the second lifting shaft (26), and wherein the motor (13) is arranged at a lower elevation than the first and second lifting shafts (25,26).

The present invention relates to a container handling vehicle for moving storage containers stacked in stacks within an automated storage and retrieval system, wherein the container handling vehicle is configured to move on a rail system above storage columns. The container handling vehicle comprises a lifting assembly which comprises a first lifting shaft and a second lifting shaft supported in an upper portion of the vehicle, and a motor for driving a drive belt for rotating the first lifting shaft and the second lifting shaft, and wherein the motor is arranged at a lower elevation than the first and second lifting shafts.

The invention further relates to an automated storage and retrieval system comprising the container handling vehicle as well as a method of lifting a storage container using the container handling vehicle.

### BACKGROUND AND PRIOR ART

FIG. 1 discloses a prior art automated storage and retrieval system 1 with a frame structure 100 and FIGS. 2, 3 and 4 disclose three different prior art container handling vehicles 201,301,401 suitable for operating on such a system 1.

The frame structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The frame structure 100 of the automated storage and retrieval system 1 comprises a rail system 108 arranged across the top of frame structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of parallel rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the frame structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a, 301a, 401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b, 301b,401b is arranged to engage with two adjacent rails of the first set of parallel rails 110, and the second set of wheels 201c,301c,401c is arranged to engage with two adjacent rails of the second set of parallel rails 111. At least one of the sets of wheels 201b, 201c, 301b, 301c,401b,401c can be lifted and lowered, so that the first set of wheels 201b, 301b,401b and/or the second set of wheels 201c, 301c,401c can be engaged with the respective set of parallel rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown. The lifting device may comprise a lifting frame 404d suspended from lifting bands 404a. The lifting bands 404a may provide power and communication between the container handling vehicle and the lifting frame 404d. The lifting frame 404d may comprise gripping engaging devices/grippers 404b for connection to gripping recesses of a storage container 106. Guide pins 404c assist in aligning the grippers 404b relative the gripping recesses of the storage container 106.

Conventionally, and also for the purpose of this application, Z=1 identifies the uppermost layer available for storage containers below the rails 110, 111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the frame structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the frame structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the frame structure 100 or transferred out of or into the frame structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the frame structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the frame structure 100 again once accessed. A port can also be used for transferring storage containers to another storage facility (e.g. to another frame structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119, 120 and the access station are located at different levels, the conveyor system may comprise a lift device with a vertical component for transporting the storage containers 106 vertically between the port column 119,120 and the access station.

The conveyor system may be arranged to transfer storage containers 106 between different frame structures, e.g. as is described in WO2014/075937A1, the contents of which are incorporated herein by reference.

A storage system may also use port columns 119,120 to transfer a storage container between the rail system 108 on top of the frame structure 100 and a container transfer vehicle arranged below a lower end of the port column. Such storage systems and suitable container transfer vehicles are disclosed in WO 2019/238694 A1 and WO 2019/238697 A1, the contents of which are incorporated herein by reference.

A potential disadvantage of using a container transfer vehicle to retrieve and deliver storage containers from/to the lower end of a port column is the time dependency between the container transfer vehicle(s) and the container handling vehicles used to retrieve/deliver the storage containers through the port column.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the frame structure 100, the content of each storage container 106; and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

An objective of the invention is to improve the drive arrangements for lifting devices of container handling vehicles.

### SUMMARY OF THE INVENTION

The present invention is set forth and characterized in the independent claims, while the dependent claims describe other characteristics of the invention.

The present invention relates to a container handling vehicle for moving storage containers stacked in stacks within an automated storage and retrieval system, wherein the container handling vehicle is configured to move on a rail system above storage columns and comprises a first set of wheels for movement on the rail system in a first direction and a second set of wheels for movement on the rail system in a second direction which is perpendicular to the first direction;
wherein the container handling vehicle comprises a lifting assembly which comprises:
   a lifting frame connectable to a storage container;
   a first lifting shaft and a second lifting shaft supported in an upper portion of the vehicle;
   two lifting bands extending from each of the first and second lifting shafts to the lifting frame;
   a first lifting shaft pulley for rotation with the first lifting shaft;
   a second lifting shaft pulley for rotation with the second lifting shaft;
   at least one guide pulley;
   a tensioning pulley for tightening and loosening a drive belt;
   a motor for driving a drive belt for rotating the first lifting shaft and the second lifting shaft;
   a drive belt pulley for outputting drive from the motor;
   a drive belt defining one closed loop, wherein the drive belt rotatably connects the first lifting shaft pulley, the second lifting shaft pulley, the at least one guide pulley, the tensioning pulley and the drive belt pulley;
   the first lifting shaft pulley is in contact with an outer surface of the drive belt; and
   the second lifting shaft pulley is in contact with an inner surface of the drive belt;
wherein the motor is arranged at a lower elevation than the first and second lifting shafts.

The first lifting shaft and the second lifting shaft may rotate in opposite directions.

According to the invention, it is only one drive belt connecting all of the pulleys. I.e. the first and second lifting shaft pulleys are driven by another component, i.e. the lower arranged motor via the drive belt.

The fact that one of the lifting shaft pulleys is in contact with the inner surface of the drive belt and the other lifting shaft pulley is in contact with the outer surface of the drive belt ensures that the first and second lifting shafts rotate in opposite directions. For this particular set-up, the shafts are set up to run in opposite directions as a result of the drive from the belt. It means that the shafts can be arranged symmetrically and the lifting bands can run off the spools to the outer sides of the spools, increasing the effective footprint marked out by the connection points to the lifting frame as compared to if the lifting shafts had rotated in the same direction and therefore contributing to the stability of the lifting.

A further advantage is that the arrangement as set forth above helps to even the amount of wear on the belt on both sides.

Arranging the motor at a lower elevation than the lifting shafts provides a lower center of gravity and thus a more stable container handling vehicle.

An angle of contact between the drive belt and the drive belt pulley may be at least 60 degrees. Preferably, the angle of contact is more than 90 degrees and even more preferably more than 120 degrees.

An angle of contact between the drive belt and the first lifting shaft pulley and the second lifting shaft pulley may be at least 60 degrees. Preferably, the angle of contact between the drive belt and the respective pulleys is more than 90 degrees and even more preferably more than 120 degrees.

The drive belt pulley may be in contact with the inner surface of the drive belt. The tensioning pulley may be arranged outside the closed loop.

At least one of the at least one guide pulleys may be arranged inside the closed loop.

The first lifting shaft pulley may be arranged outside the closed loop and the guide pulley closest to the first lifting shaft pulley is arranged inside the closed loop.

An axis of the guide pulley which is closest to the first lifting shaft pulley may be arranged at a higher elevation than an axis of the first lifting shaft pulley.

Two guide pulleys of the at least one guide pulley may be arranged inside the closed loop.

The lifting assembly may comprise an L-shaped carrier that supports the two guide pulleys.

It may be advantageous to have at least two guide pulleys and one tensioning pulley to obtain proper contact between drive belt and the respective wheels.

The other guide pulley of the at least one guide pulley arranged within the closed loop may be arranged at substantially the same distance from the first lifting shaft pulley as the guide pulley which is closest to the first lifting shaft pulley and may have a centre axis which is at a lower elevation than the centre axis of the first lifting shaft pulley.

The centre axis of the other guide pulley of the at least one guide pulley may be arranged in a vertical plane which is at a further distance from a midpoint between the first and second lifting shafts than a distance between the midpoint and the centre axis of the first lifting shaft pulley.

The tensioning pulley may be mounted on an eccentric. This results in that upon displacing the tensioning pulley relative the eccentric will tension or loosen the drive belt.

A diameter of the first lifting shaft pulley and the second lifting shaft pulley may be larger than a diameter of the drive belt pulley, the at least one guide pulley and the tensioning pulley. The fact that the lifting shaft pulleys have a larger diameter than the drive belt pulley means that they are going to turn slower than the drive belt pulley but on a plus-side it means there is potentially more control over the lifting operations and the lifting frame may be better able to lift heavier loads.

The first lifting shaft and the second lifting shaft are preferably parallel.

The lifting frame may be connectable to a storage container from above. I.e., lifting frame connects to the top of the storage container.

The lifting assembly is configured to lift a storage container to a position above a lowest level of the first and second sets of wheels. As such, the container handling vehicle can move on top of the rail system while carrying a storage container.

The drive belt is preferably double cogged. I.e., the drive belt is cogged both on the inside and on the outside. This means that the drive belt is able to grip the pulleys (which can be arranged both inside and outside the drive belt) more properly. Similarly, all of the pulleys may also be cogged to ensure proper grip between the drive belt and the respective pulleys. In addition, all of the pulleys are preferably arranged in the same vertical plane.

The first lifting shaft pulley and the second lifting shaft pulley are preferably a pair of pulleys of the same diameter.

The motor may comprise a brake device in the form of a ratchet device for braking the rotation of the first lifting shaft and the second lifting shaft. The brake device is configured to brake or lock rotation of the first and second lifting shaft by locking or braking rotation of the drive belt. The braking is preferably used during lowering to stop or reduce downward movement or acceleration of the lifting frame (and any connected storage container) when at target depth.

In one aspect, the brake device is arranged on an opposite side of the motor compared to the first and second lifting shafts. The setup of the container handling vehicle according to the present invention provides more space on the opposite side of the motor compared to the first and second lifting shafts. As a result of arranging the motor as is in the current setup, more space is available both for a larger motor as well as for other additional or more space-demanding components compared to some prior art solutions.

According to a first embodiment of the container handling vehicle, the container handling vehicle comprises a vehicle module part and a cantilever part, and the cantilever part extends sideways from the vehicle module part, and the first set of wheels, the second set of wheels and the motor are arranged in the vehicle module part. Arranging the motor in the vehicle module part provides for the possibility of using larger motors because there are less restrictions in terms of space.

In one aspect of the first embodiment of the container handling vehicle, the drive belt, the first lifting shaft pulley, the second lifting shaft pulley and the at least one guide pulley is arranged in the vehicle module part.

According to a second embodiment of the container handling vehicle, the container handling vehicle comprises a vehicle frame defining a first section and a second section of the container handling vehicle arranged side-by-side, and wherein the second section comprises a cavity for accommodating a storage container, and wherein the motor is arranged in the first section.

The present invention also relates to an automated storage and retrieval system comprising: a rail system comprising a first set of parallel tracks arranged in a horizontal plane and extending in a first direction, and a second set of parallel tracks arranged in the horizontal plane and extending in a second direction which is orthogonal to the first direction, which first and second sets of tracks form a grid pattern in the horizontal plane comprising a plurality of adjacent grid cells, each comprising an access opening defined by a pair of neighboring tracks of the first set of tracks and a pair of neighboring tracks of the second set of tracks; and a plurality of stacks of storage containers arranged in storage columns located beneath the rail system, wherein each storage column is located vertically below an access opening and wherein the automated storage and retrieval system comprises at least one container handling vehicle as defined above.

It is further described a method of lifting a storage container using the container handling vehicle as defined above, wherein the method comprises the steps of:
positioning the container handling vehicle above a stack of storage containers in a storage column, wherein the stack comprises a target storage container;
operating the motor in a first direction to rotate the drive belt and thus the first lifting shaft and the second lifting shaft thereby lowering the lifting frame into contact with an uppermost storage container of the stack;
stopping the motor when the lifting frame is in contact with the uppermost storage container;
connecting the lifting frame to the uppermost storage container;
operating the motor in a second direction, which second direction is opposite the first direction, to rotate the drive belt and thus the first lifting shaft and the second lifting shaft thereby lifting the lifting frame and the connected storage container above the rail system.

The first lifting shaft and the second lifting shaft may rotate in opposite directions.

The automated storage and retrieval system may comprise a plurality of upright members and each storage column is defined by four of the upright members.

The rail system may be arranged on top of the upright members, the rail system comprising a first set of parallel rails and a second set of parallel rails arranged perpendicular to the first set of rails. The first and second set of rails providing a horizontal grid-based rail system defining a plurality of grid cells. The rails of the rail system may comprise one or two tracks. Preferably both directions of rail comprise two tracks (double tracks), e.g., either as two parallel channels formed in a rail, or as a channel provided in each of a pair of rail members that have been fastened to the other to form a rail. In such arrangements the access opening (also named grid opening) and a track-width on each side defines the “grid cell”. In arrangements where one direction of rails has only a single track, the grid cell may extend a full rail-width on those sides.

One access opening including a track of each of the rails adjacent the occupied access opening is also denoted “a grid cell”. A grid cell may be defined as the cross-sectional area, including width of the rails, between the midpoint of two rails running in the first direction and the midpoint of two rails running in the second direction.

In the present specification the term “storage container” is intended to mean any goods holder unit having a bottom plate and side portions suitable for releasable connection to the container lift device, e.g. a bin, a tote, a tray or similar. The side portions may preferably comprise gripping recesses. The side portions are preferably sidewalls. The height of the sidewalls may vary depending on the intended use of the automated storage and retrieval system and the goods to be stored. The gripping recesses may be arranged at an upper rim of the sidewalls. The outer horizontal periphery of the storage container is preferably rectangular.

The relative terms “upper”, “lower”, “below”, “above”, “higher” etc. shall be understood in their normal sense and as seen in a cartesian coordinate system.

The invention may be used in connection with storage containers and systems as described above. However, other areas where the disclosed automated storage and retrieval system and methods may be used is within vertical farming, micro-fulfilment or grocery/e-grocery.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a frame structure of a prior art automated storage and retrieval system;

FIG. 2 is a perspective view of a prior art container handling vehicle having an internally arranged cavity for carrying storage containers therein;

FIG. 3 is a perspective view of a prior art container handling vehicle having a cantilever for carrying storage containers underneath;

FIG. 4 is a perspective view, seen from below, of a prior art container handling vehicle having an internally arranged cavity for carrying storage containers therein;

FIG. 5 is a perspective view of the container handling vehicle in FIG. 4 without side and top panels;

FIGS. 6A-6D show a container handling vehicle according to a first embodiment of the invention which container handling vehicle comprises a vehicle module part and a cantilever part, wherein the cantilever part extends sideways from the vehicle module part;

FIG. 6A is a perspective view of the container handling vehicle according to the first embodiment operating on a rail system of an automated storage and retrieval system;

FIG. 6B is a view of the container handling vehicle according to the first embodiment where the side and top panels have been removed in order to better illustrate the different components inside the vehicle module part;

FIG. 6C is a perspective side view showing details of a lifting assembly of the container handling vehicle according to the first embodiment of the invention;

FIG. 6D is a top view of the lifting assembly in FIG. 6C;

FIGS. 7A-7G show a container handling vehicle according to a second embodiment of the invention comprising a vehicle frame defining a first section and a second section of the container handling vehicle arranged side-by-side, and wherein the second section comprises a cavity for accommodating a storage container;

FIG. 7A is a perspective view of the container handling vehicle according to the second embodiment of the invention;

FIG. 7B is a view of the container handling vehicle in FIG. 7A where the side and top panels have been removed in order to better illustrate the different components inside the container handling vehicle;

FIG. 7C is a view inside the second section of the container handling vehicle in FIGS. 7A and 7B;

FIG. 7D is a detailed view of section A in FIG. 7C;

FIG. 7E is a similar view as FIG. 7C but where the first and second lifting shafts have been removed to better illustrate the setup of the drive belt and pulleys;

FIG. 7F is a perspective side view showing details of a lifting assembly of the container handling vehicle according to the second embodiment of the invention;

FIG. 7G is a perspective view from the opposite side compared to FIG. 7F;

FIG. 8 shows an alternative setup of the drive belt connecting the first lifting shaft pulley, the second lifting shaft pulley, one guide pulley, drive belt pulley and the tensioning pulley compared to FIGS. 6-7;

FIG. 9 is a detailed view of a drive belt which can be used as the drive belt in any of the container handling vehicles according to the first and second embodiments of the invention.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

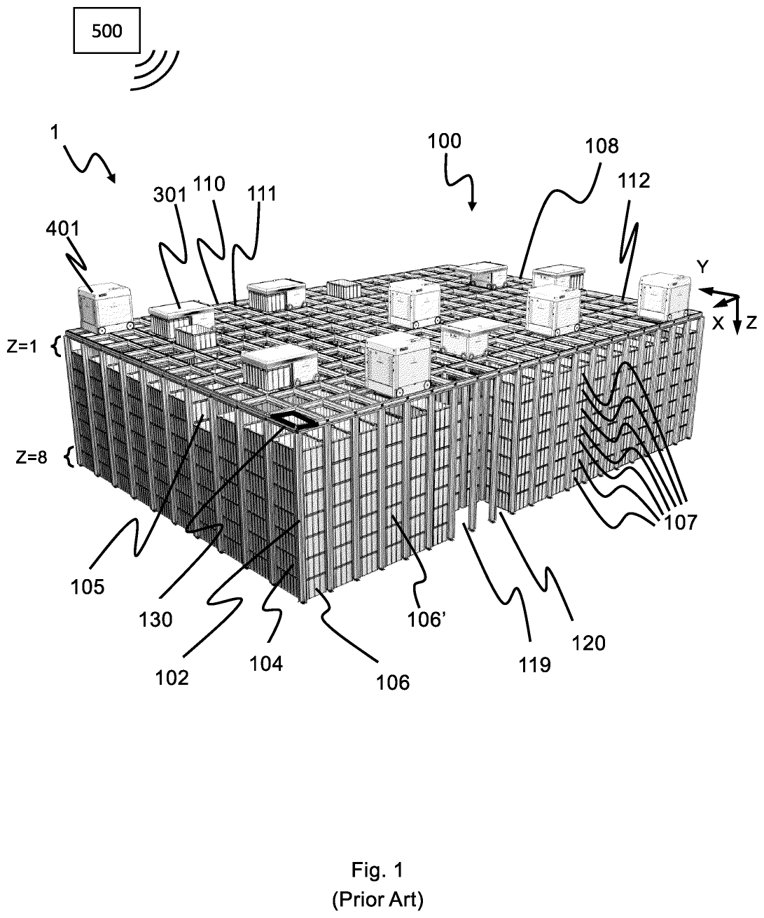

A frame structure 100 of the automated storage and retrieval system 1 may be constructed in a similar manner to the prior art frame structure 100 described above in connection with FIG. 1. That is, the frame structure 100 may comprise a number of upright members 102, and comprise a first, upper rail system 108 extending in the X direction and Y direction.

The frame structure 100 may comprise storage compartments in the form of storage columns 105 provided between the members 102 wherein storage containers 106 may be stackable in stacks 107 within the storage columns 105.

The frame structure 100 can be of any size. In particular, it is understood that the frame structure can be considerably wider and/or longer and/or deeper than disclosed in FIG. 1. For example, the frame structure 100 may have a horizontal extent of more than 700×700 columns and a storage depth of more than twelve containers.

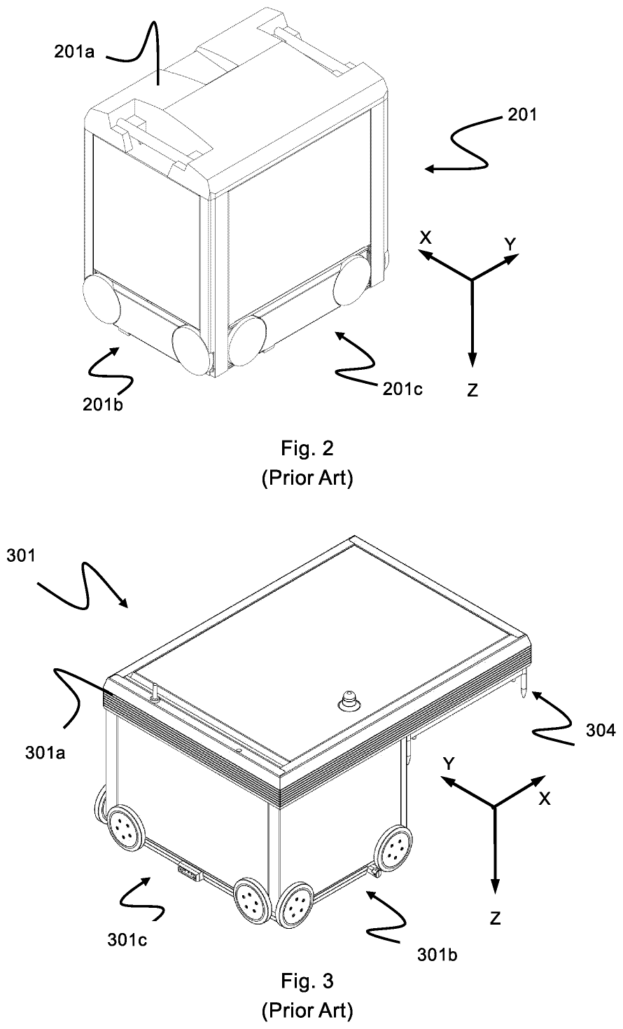

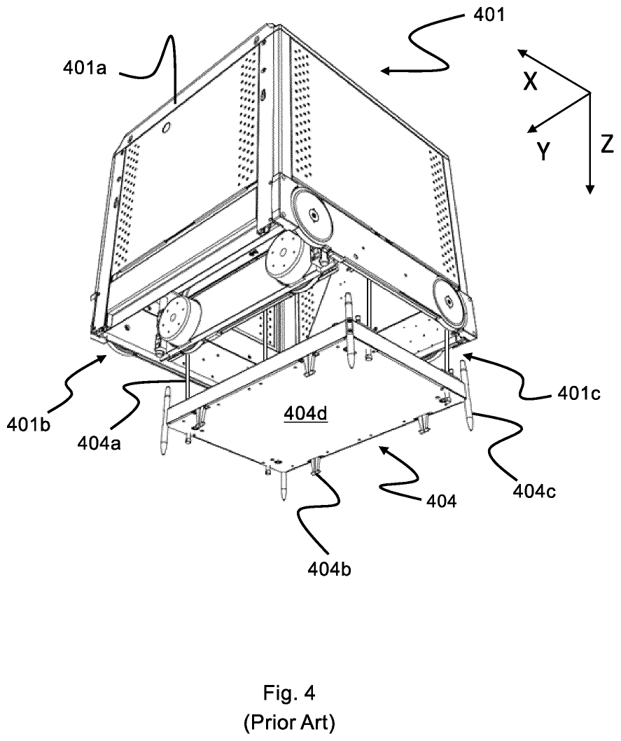

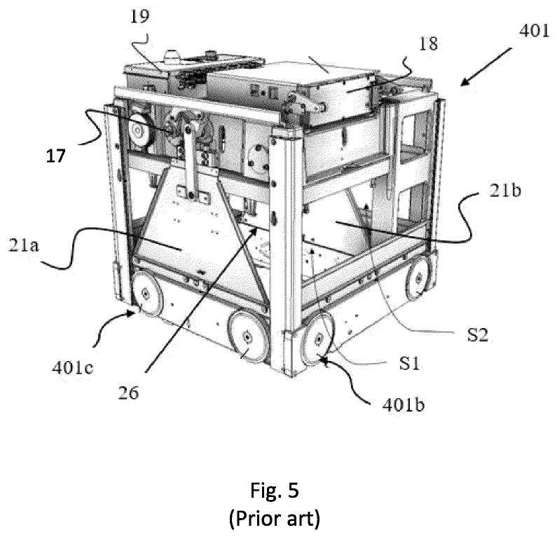

The prior art container handling vehicles comprising a cavity for accommodating a storage container, see FIGS. 2, 4 and 5, have certain advantageous features. In particular, the guidance/support provided to a storage container when accommodated in the cavity entails that the vehicles may have increased acceleration/retardation relative to the cantilevered container handling vehicle 301 shown in FIG. 3. However, the potential increase in acceleration/retardation is not fully realized due to instability of the vehicles. The instability is caused by both vehicles 201,401 having most of the drive, power, control and lifting components arranged above the cavity, providing a high centre of gravity.

The rail system 108 may be arranged on top of the upright members 102, the rail system 108 comprising a first set of parallel rails 110 and a second set of parallel rails 111 arranged perpendicular to the first set of rails 110. The first and second set of rails 110,111 providing a horizontal grid-based rail system 108 defining a plurality of grid cells 130. The rails 110,111 of the rail system 108 may comprise one or two tracks. Preferably both directions of rail comprise two tracks (double tracks), e.g., either as two parallel channels formed in a rail, or as a channel provided in each of a pair of rail members that have been fastened to the other to form a rail. In such arrangements the access opening (also named grid opening) and a track-width on each side defines the “grid cell” 130. In arrangements where one direction of rails has only a single track, the grid cell 130 may extend a full rail-width on those sides.

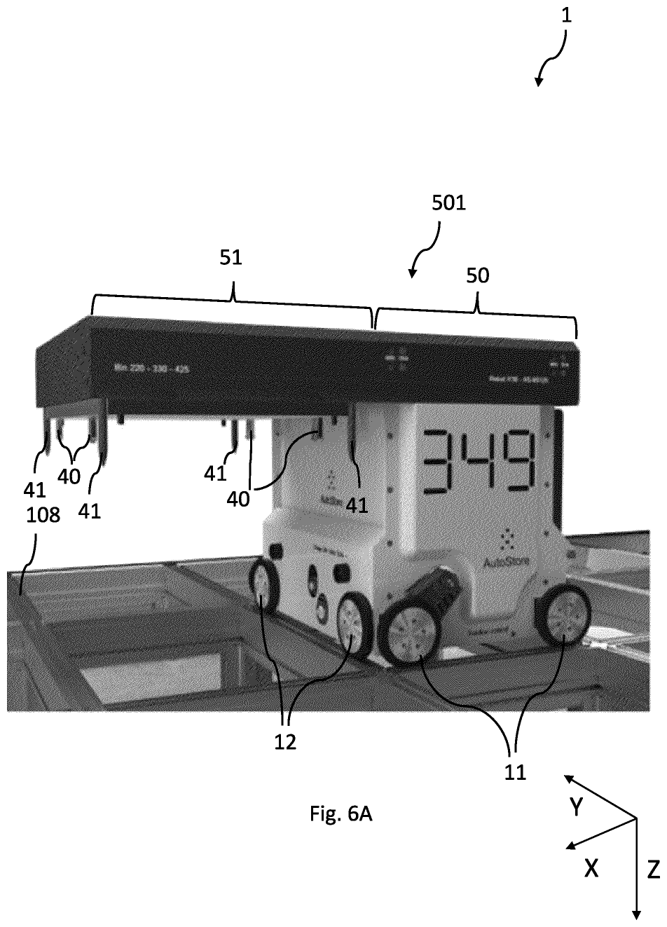

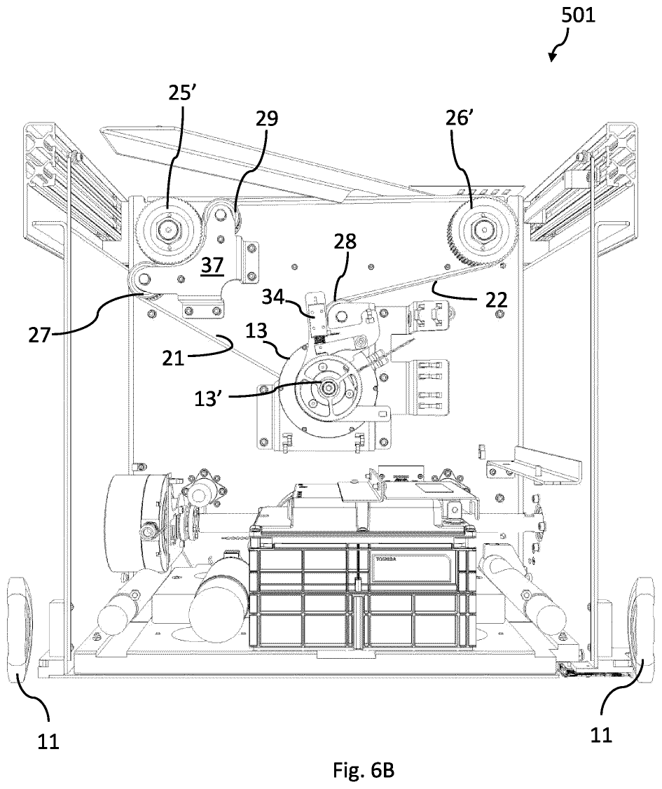

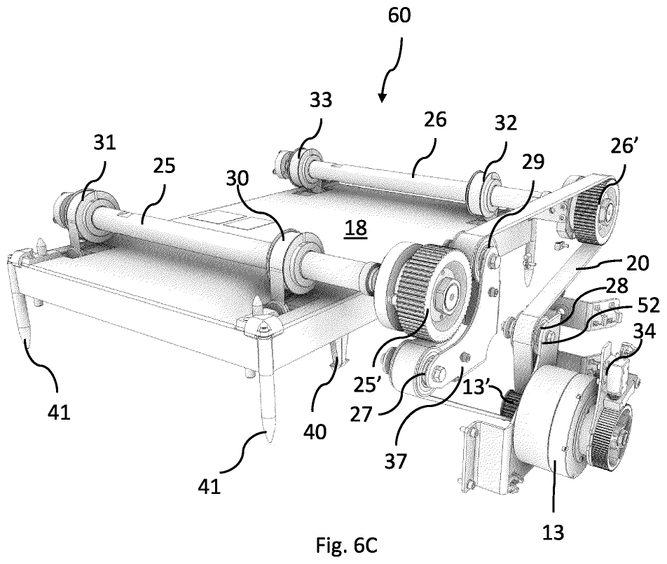

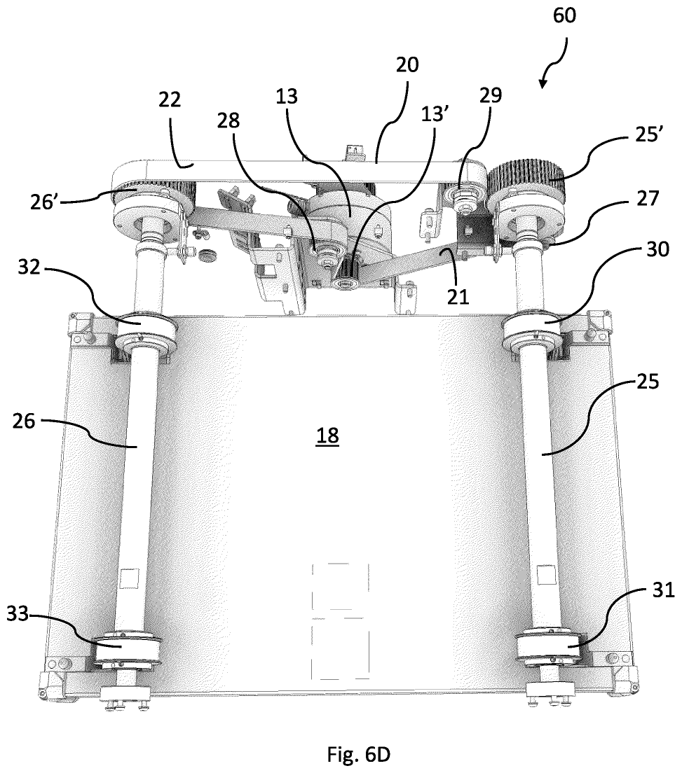

FIG. 6A is a perspective view of the container handling vehicle 501 according to the first embodiment operating on a rail system 108 of an automated storage and retrieval system 1. The container handling vehicle 501 comprises a vehicle module part 50 and a cantilever part 51. The cantilever part 51 extends sideways from the vehicle module part 50. The first set of wheels 11, the second set of wheels 12 and the motor 13 are arranged in the vehicle module part 50.

FIG. 6B is a view of the container handling vehicle 501 according to the first embodiment where the side and top panels have been removed in order to better illustrate the different components inside the vehicle module part 50.

FIG. 6C is a perspective side view showing details of a lifting assembly 60 of the container handling vehicle 501 according to the first embodiment of the invention.

FIG. 6D is a top view of the lifting assembly 60 in FIG. 6C.

Now referring to FIGS. 6B-6D, the components forming part of the lifting assembly 60 used in the container handling vehicle 501 according to the first embodiment of the invention will be described in greater detail.

As shown in the Figures the lifting assembly 60 comprises a lifting frame 18 connectable to a storage container 106. The lifting frame 18 features four grippers 40 for connection to a storage container from above and four guide pins 41 for aligning the lifting frame 18 relative the storage container 106. A first lifting shaft 25 and a second lifting shaft 26 are supported in an upper portion of the vehicle 501. The first and second lifting shafts 25,26 are parallel such that the lifting frame 18 is lifted mainly in a horizontal plane. Two lifting bands 30,31; 32,33 extend from each of the first and second lifting shafts 25,26 to the lifting frame 18. The lifting bands 30,31,32,33 are preferably made of a conductive material and provide power and communication between the container handling vehicle 501 and the lifting frame 18. A first lifting shaft pulley 25′ is provided at one end of the first lifting shaft 25 and rotates together with the first lifting shaft 25. Similarly, a second lifting shaft pulley 26′ is provided at one end of the second lifting shaft 26 and rotates together with the second lifting shaft 26. The first and second lifting shaft pulleys 25′,26′ are arranged on the same side of the container handling vehicle 501 as well as they are arranged in the same vertical plane. Two guide pulleys 27,29, and a tensioning pulley 29 for tightening and loosening a drive belt 20, are arranged in the same vertical plane as the first and second lifting shaft pulleys 25′,26′. The lifting assembly 60 further comprises a motor 13 for driving a drive belt 20 for rotating the first lifting shaft 25 and the second lifting shaft 26. A drive belt pulley 13′ is arranged at an end of a rotational axis of the motor 13 and is configured for outputting drive from the motor 13. The drive belt 20 defines one closed loop, wherein the drive belt 20 rotatably connects the first lifting shaft pulley 25′, the second lifting shaft pulley 26′, the at least one guide pulley 27,29, the tensioning pulley 28 and the drive belt pulley 13′. As such, one single common drive belt 20 is used for rotating both the first and the second lifting shaft 25,26. The first lifting shaft pulley 25′ is in contact with an outer surface 22 of the drive belt 20 and the second lifting shaft pulley 26′ is in contact with an inner surface 21 of the drive belt 20. As seen in the Figures, the motor 13 is arranged at a lower elevation than the first and second lifting shafts 25,26.

The setup of the drive belt 20 relative the first and second lifting shaft pulleys 25′,26′, i.e. that the first lifting shaft pulley 25′ is arranged outside the closed loop and the second lifting shaft pulley 26′ is arranged the closed loop, results in that the first and second lifting shafts 25,26 rotate in opposite directions.

As seen in the Figures, a significant length of the drive belt 20 is in contact with the drive belt pulley 13′. The contact length, i.e. the angle of contact, between the drive belt 20 and the drive belt pulley 13′ is preferably at least 60 degrees. In the figures, the drive belt pulley 13′ is inside the closed loop, i.e. the drive belt pulley 13′ is in contact with the inner surface of the drive belt 20. In other configurations (not shown), the drive belt pulley 13′ could be arranged outside the closed loop, i.e. in contact with the outer surface of the drive belt 20.

Similarly, the angle of contact between the drive belt 20 and the respective first lifting shaft pulley 25′, the second lifting shaft pulley 26′, the tensioning pulley 28 and the two guide pulleys 27,29 are also at least 60 degrees.

As shown, the tensioning pulley 28 is arranged outside the closed loop. However, in other configurations (not shown), the tensioning pulley 28 could be arranged outside the closed loop, i.e. in contact with the outer surface of the drive belt 20. The tensioning pulley 28 could be mounted on an eccentric, such that upon moving the tensioning pulley 28 laterally would tighten or loosen the drive belt 20.

The two guide pulleys 27, are arranged inside the closed loop. However, in other configurations (not shown), at least one of the guide pulleys 27,29 could be arranged outside the closed loop, i.e. in contact with the outer surface of the drive belt 20.

An axis of the guide pulley 29 which is closest to the first lifting shaft pulley 25′ is arranged at a higher elevation than an axis of the first lifting shaft pulley 25′. This ensures a sufficient angle of contact between the first lifting shaft pulley 25′ and the drive belt 20. An L-shaped carrier 37 supports the two guide pulleys 27,29, and one guide pulley is arranged in each of the ends of the L-shaped carrier 37. In order to further increase the angle of contact between the first lifting shaft pulley 25′ and the drive belt 20, the L-shaped carrier 37 encloses parts of the first lifting shaft pulley 25′. The other of the two guide pulleys 27 is arranged in substantially the same distance from the first lifting shaft pulley 25′ as the guide pulley 29 which is closest to the first lifting shaft pulley 25′ and has a centre axis which is at a lower elevation than the centre axis of the first lifting shaft pulley 25′. Furthermore, the centre axis of the other guide pulley 27 is arranged in a vertical plane which is at a further distance from a midpoint between the first and second lifting shafts 25,26 than a distance between the midpoint and the centre axis of the first lifting shaft pulley 25′.

As seen in the Figures, a diameter of the first lifting shaft pulley 25′ and the second lifting shaft pulley 26′ is larger than a diameter of the drive belt pulley 13′, the at least one guide pulley 27,29 and the tensioning pulley 28. The first lifting shaft pulley 25′ and the second lifting shaft pulley 26′ are shown as a pair of pulleys of the same diameter.

As shown, the motor 13 comprises a brake device 34 in the form of a ratchet device for braking the rotation of the first lifting shaft 25 and the second lifting shaft 26. As seen in the Figures, the brake device 34 is arranged on an opposite side of the motor 13 compared to the first and second lifting shafts 25,26 and is mounted on a through-going shaft of the motor 13, i.e. a shaft which extends from a position at one end of the motor 13 and to a position on an opposite end of the motor 13.

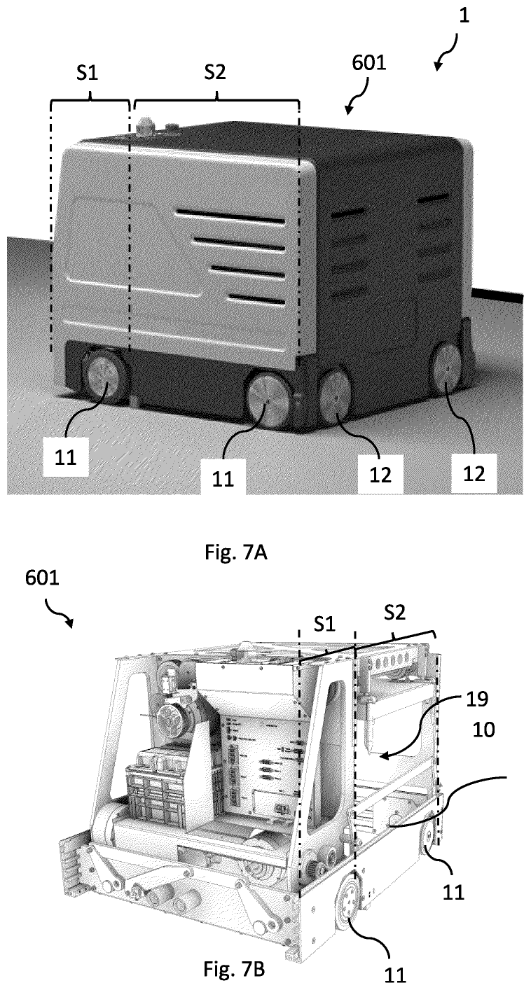

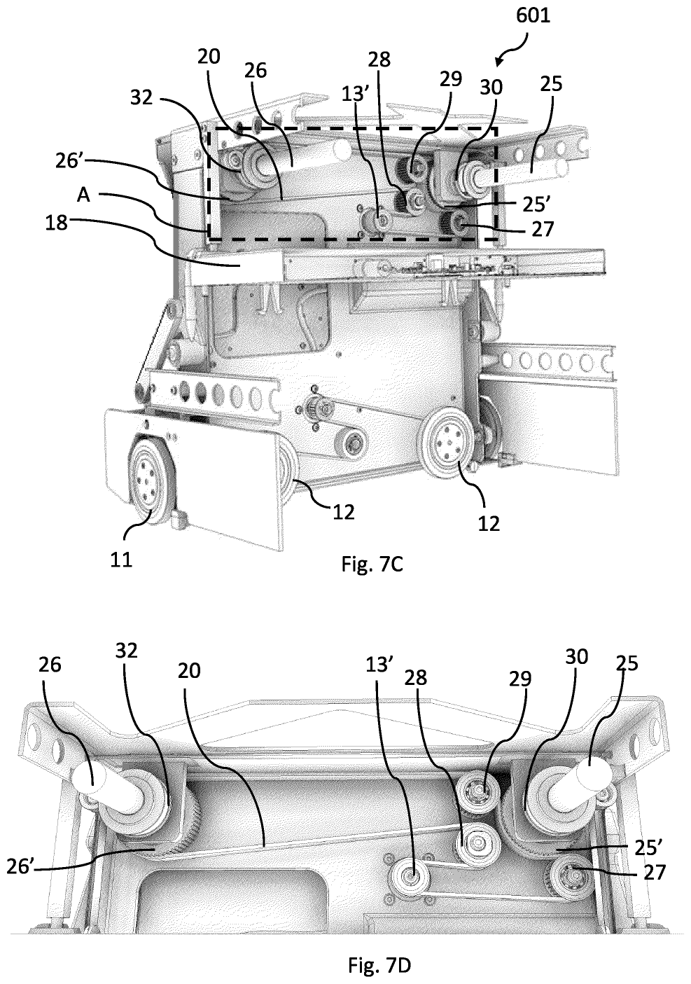

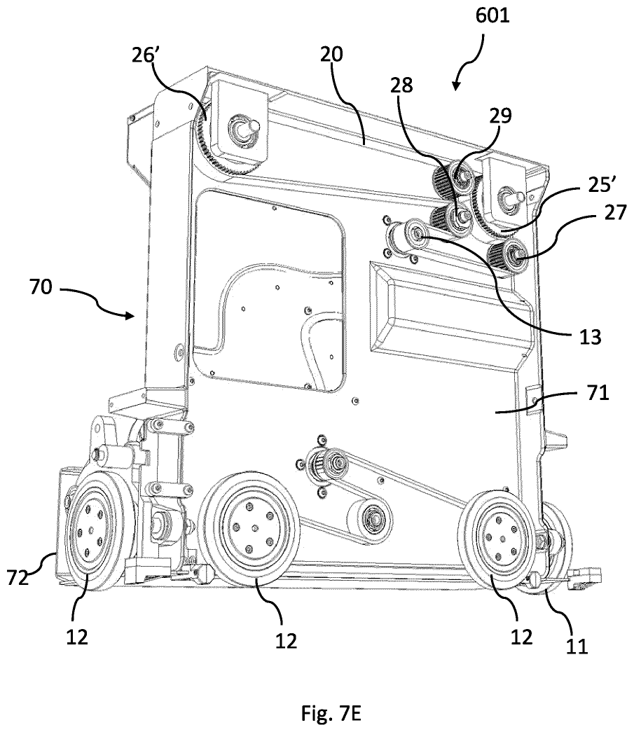

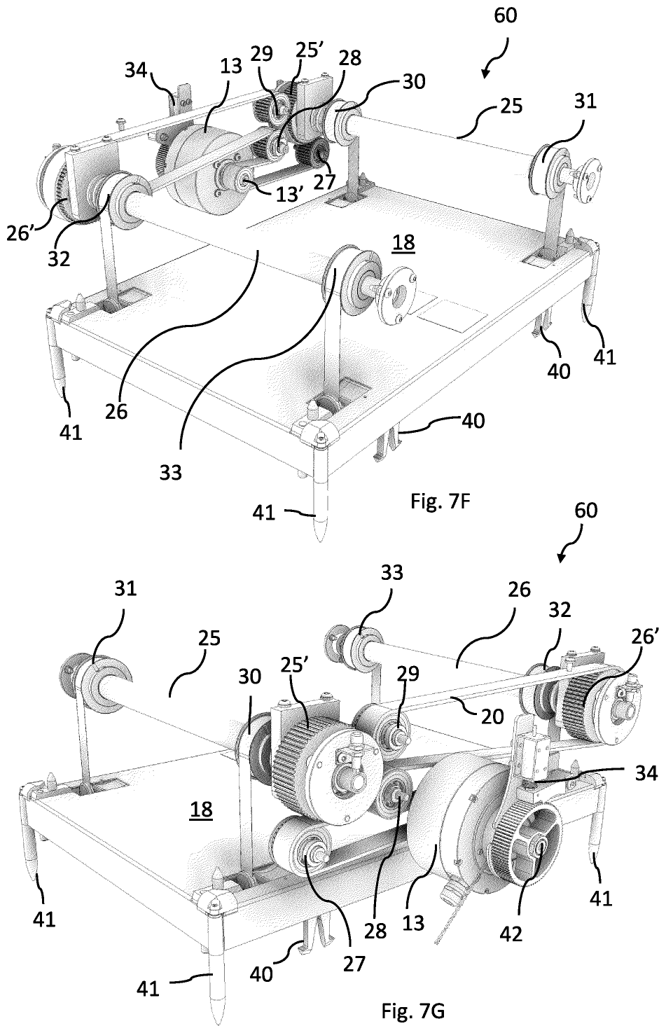

FIGS. 7A-7G show a container handling vehicle 601 according to a second embodiment of the invention comprising a vehicle frame 10 defining a first section S1 and a second section S2 of the container handling vehicle 601 arranged side-by-side, and wherein the second section S2 comprises a cavity 19 for accommodating a storage container 106.

FIG. 7A is a perspective view of the container handling vehicle according to the second embodiment of the invention. The container handling vehicle according to the second embodiment of the invention can operate on a rail system 108 (rail system 108 not shown in FIG. 7A, but see e.g. FIG. 6A). The container handling vehicle 601 comprises a vehicle frame 10 defining a first section S2 and a second section S2 of the container handling vehicle arranged side-by-side, and wherein the second section S2 comprises a cavity 19 for accommodating a storage container 106. The motor 13 is arranged in the first section S1.

FIG. 7B is a view of the container handling vehicle 601 in FIG. 7A where the side and top panels have been removed in order to better illustrate the different components inside the container handling vehicle 601.

FIG. 7C is a view inside the second section of the container handling vehicle 601 in FIGS. 7A and 7B.

FIG. 7D is a detailed view of section A in FIG. 7C.

FIG. 7E is a similar view as FIG. 7C but where the first and second lifting shafts have been removed to better illustrate the setup of the drive belt 20 and pulleys 13′,25′,26′, 27, 28, 29.

FIG. 7F is a perspective side view showing details of a lifting assembly 60 of the container handling vehicle 601 according to the second embodiment of the invention.

FIG. 7G is a perspective view from the opposite side compared to FIG. 7F.

Referring to FIGS. 7C-7G, the setup of the lifting assembly 60 for the container handling vehicle 601 according to the second embodiment of the invention is in majority the same as the lifting assembly 60 for the container handling vehicle 501 according to the first embodiment of the invention except that the motor 13, the drive belt pulley 13′ and the tensioning pulley 28 are arranged at a somewhat higher elevation compared to lifting assembly 60 for the container handling vehicle 501 according to the first embodiment of the invention. The relative positions of the remaining components of the lifting assembly 60 are more or less identical to the components in the lifting assembly 60 for the container handling vehicle 501 according to the first embodiment of the invention and will not be repeated herein.

Referring to FIG. 7E, a module 70 for simplifying assemblage of the container handling vehicle 601 is shown. The module 70 is formed of a vertical wall panel 71 and a horizontal base 72. Two of the wheels in the first set of wheels 11 and two of the wheels in the second set of wheels 12 are connected to the base 72. Due to available space within the base 72 resulting from the extension of the base 72 laterally and vertically, all of the wheels connected to the base may be motorized. Furthermore, the first lifting shaft pulley 25′, the second lifting shaft pulley 26′, the at least one guide pulley 27,29, the tensioning pulley 28, the motor 13, the drive belt pulley 13′ and the drive belt 20 are mounted on the wall panel 71. During assemblage of container handling vehicle 610, all of the components of the module 70 shown in FIG. 7E may be pre-mounted before the fully-mounted module 70 in FIG. 7R is connected to the vehicle frame 10 (see e.g. FIG. 7B).

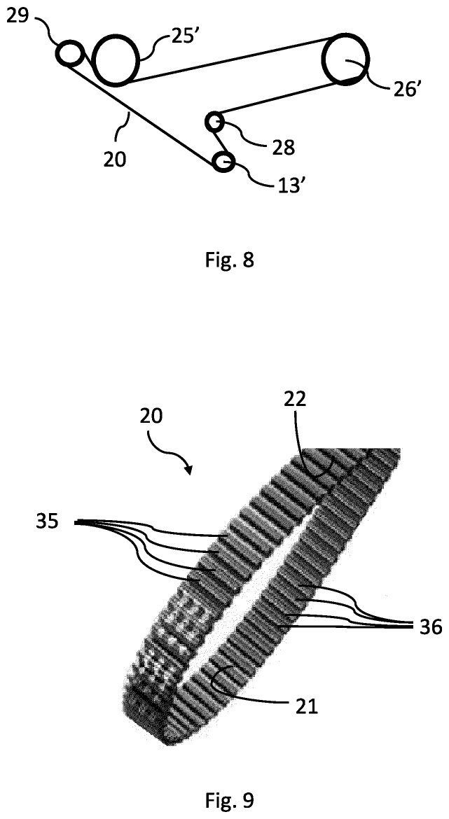

FIG. 8 shows an alternative setup of the single drive belt 20 connecting the first lifting shaft pulley 25′, the second lifting shaft pulley 26′, one guide pulley 29, drive belt pulley 13′ and the tensioning pulley 28. As seen in the Figure, and when comparing with the drive belt setup in FIGS. 6-7,

FIG. 9 is a detailed view of a drive belt 20 which can be used as the drive belt 20 in any of the container handling vehicles 501,601 according to the first and second embodiments. As seen in FIG. 9, the drive belt 20 is double-cogged and features external cogs 35 on its outside and internal cogs 36 on its inside. The double-cogged drive belt 20 provides a better grip on the respective pulleys 13′, 25′, 26′, 28, 29.

In the preceding description, various aspects of the independent claims have been described. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention as defined in the attached claims.

### LIST OF REFERENCE NUMBERS

| | |
|---|---|
| 1 | Prior art automated storage and retrieval system |
| 10 | Vehicle frame |
| 11 | First set of wheels |
| 12 | Second set of wheels |
| 13 | Motor |
| 13′ | Drive belt pulley |
| 18 | Lifting frame |
| 19 | Cavity |
| 20 | Drive belt |
| 21 | Inner surface of drive belt |
| 22 | Outer surface of drive belt |
| 25 | First lifting shaft |
| 25′ | First lifting shaft pulley |
| 26 | Second lifting shaft |
| 26′ | Second lifting shaft pulley |
| 27 | Guide pulley |
| 28 | Tensioning pulley |
| 29 | Guide pulley |
| 30 | First lifting element/lifting band |
| 31 | Second lifting element/lifting band |
| 32 | Third lifting element/lifting band |
| 33 | Fourth lifting element/lifting band |
| 34 | Brake device/ratchet |
| 35 | External cogs |
| 36 | Internal cogs |
| 37 | L-shaped carrier |
| 40 | Gripper |
| 41 | Guide pin |
| 42 | Through-going shaft |
| 50 | Vehicle module part |
| 51 | Cantilever part |
| 52 | Eccentric |
| 60 | Lifting assembly |
| 70 | Module |
| 71 | Wall panel |
| 72 | Base |
| 100 | Frame structure |
| 102 | Upright member |
| 104 | Storage volume |
| 105 | Storage column |
| 106 | Storage container |
| 106′ | Particular position of storage container |
| 107 | Stack |
| 108 | Rail system |
| 110 | First set of parallel tracks (in first direction (X)) |
| 111 | Second set of parallel tracks (in second direction (Y)) |
| 112 | Access opening |
| 130 | Grid cell |
| 201 | Prior art container handling vehicle |
| 201a | Vehicle body of the container handling vehicle 201 |
| 201b | Drive means/wheel arrangement/first set of wheels in first |
| | direction (X) |
| 201c | Drive means/wheel arrangement/second set of wheels in second |
| | direction (Y) |
| 301 | Prior art cantilever container handling vehicle |
| 301a | Vehicle body of the container handling vehicle 301 |
| 301b | Drive means/first set of wheels in first direction (X) |
| 301c | Drive means/second set of wheels in second direction (Y) |
| 401 | Prior art container handling vehicle |
| 401a | Vehicle body of the container handling vehicle 401 |
| 401b | Drive means/first set of wheels in first direction (X) |
| 401c | Drive means/second set of wheels in second direction (Y) |
| 404 | Gripping device |
| 404a | Lifting band |
| 404b | Gripper |
| 404c | Guide pin |
| 404d | Lifting frame |
| 500 | Control system |
| 501 | Container handling vehicle according to first embodiment |
| 601 | Container handling vehicle according to second embodiment |
| P | Horizontal plane |
| S1 | First section |
| S2 | Second section |
| X | First direction |
| Y | Second direction |
| Z | Third direction |

1.-28. (canceled)

29. A container handling vehicle for moving storage containers stacked in stacks within an automated storage and retrieval system, wherein the container handling vehicle is configured to move on a rail system above storage columns and comprises a first set of wheels for movement on the rail system in a first direction and a second set of wheels for movement on the rail system in a second direction which is perpendicular to the first direction;
wherein the container handling vehicle comprises a lifting assembly which comprises:
a lifting frame connectable to a storage container;
a first lifting shaft and a second lifting shaft supported in an upper portion of the vehicle;
two lifting bands extending from each of the first and second lifting shafts to the lifting frame;
a first lifting shaft pulley for rotation with the first lifting shaft;
a second lifting shaft pulley for rotation with the second lifting shaft;
at least one guide pulley;
a tensioning pulley for tightening and loosening a drive belt;
a motor for driving a drive belt for rotating the first lifting shaft and the second lifting shaft;
a drive belt pulley for outputting drive from the motor;
a drive belt defining one closed loop, wherein the drive belt rotatably connects the first lifting shaft pulley, the second lifting shaft pulley, the at least one guide pulley, the tensioning pulley and the drive belt pulley;
the first lifting shaft pulley is in contact with an outer surface of the drive belt; and
the second lifting shaft pulley is in contact with an inner surface of the drive belt;
wherein the motor is arranged at a lower elevation than the first and second lifting shafts.

30. The container handling vehicle of claim 29, wherein the first lifting shaft and the second lifting shaft rotate in opposite directions.

31. The container handling vehicle of claim 29, wherein an angle of contact between the drive belt and the drive belt pulley is at least 60 degrees.

32. The container handling vehicle of claim 29, wherein an angle of contact between the drive belt and the first lifting shaft pulley and the second lifting shaft pulley is at least 60 degrees.

33. The container handling vehicle of claim 29, wherein the drive belt pulley is in contact with the inner surface of the drive belt.

34. The container handling vehicle of claim 32, wherein the tensioning pulley is arranged outside the closed loop.

35. The container handling vehicle of claim 29, wherein at least one of the at least one guide pulley is arranged inside the closed loop.

36. The container handling vehicle of claim 34, wherein the first lifting shaft pulley is arranged outside the closed loop and the guide pulley closest to the first lifting shaft pulley is arranged inside the closed loop.

37. The container handling vehicle of claim 34, wherein an axis of the guide pulley which is closest to the first lifting shaft pulley is arranged at a higher elevation than an axis of the first lifting shaft pulley.

38. The container handling vehicle of claim 34, wherein two guide pulleys of the at least one guide pulley are arranged inside the closed loop.

39. The container handling vehicle according to claim 38, wherein the lifting assembly comprises an L-shaped carrier that supports the two guide pulleys.

40. The container handling vehicle of claim 34, wherein the other guide pulley of the at least one guide pulley arranged within the closed loop is arranged at substantially the same distance from the first lifting shaft pulley as the guide pulley which is closest to the first lifting shaft pulley and has a center axis which is at a lower elevation than the center axis of the first lifting shaft pulley.

41. The container handling vehicle of claim 34, wherein the center axis of the other guide pulley of the at least one guide pulley is arranged in a vertical plane which is at a further distance from a midpoint between the first and second lifting shafts than a distance between the midpoint and the center axis of the first lifting shaft pulley.

42. The container handling vehicle of claim 29, wherein the tensioning pulley is mounted on an eccentric.

43. The container handling vehicle of claim 29, wherein a diameter of the first lifting shaft pulley and the second lifting shaft pulley is larger than a diameter of the drive belt pulley, the at least one guide pulley, and the tensioning pulley.

44. The container handling vehicle of claim 29, wherein the first lifting shaft and the second lifting shaft are parallel.

45. The container handling vehicle of claim 29, wherein the lifting frame is connectable to a storage container from above.

46. The container handling vehicle of claim 29, wherein the lifting assembly is configured to lift a storage container to a position above a lowest level of the first and second sets of wheels.

47. The container handling vehicle of claim 29, wherein the drive belt is double cogged.

48. The container handling vehicle of claim 29, wherein the first lifting shaft pulley and the second lifting shaft pulley are a pair of pulleys of a same diameter.

49. The container handling vehicle of claim 29, wherein the motor comprises a brake device in the form of a ratchet device for braking the rotation of the first lifting shaft and the second lifting shaft.

50. The container handling vehicle of claim 49, wherein the brake device is arranged on an opposite side of the motor compared to the first and second lifting shafts.

51. The container handling vehicle of claim 29, wherein the container handling vehicle comprises a vehicle module part and a cantilever part, wherein the cantilever part extends sideways from the vehicle module part, and wherein the first set of wheels, the second set of wheels and the motor are arranged in the vehicle module part.

52. The container handling vehicle of claim 51, wherein the drive belt, the first lifting shaft pulley, the second lifting shaft pulley, and the at least one guide pulley are arranged in the vehicle module part.

53. The container handling vehicle of claim 29, wherein the container handling vehicle comprises a vehicle frame defining a first section and a second section of the container handling vehicle arranged side-by-side, and wherein the second section comprises a cavity for accommodating a storage container, and wherein the motor is arranged in the first section.

54. An automated storage and retrieval system comprising:
a rail system comprising a first set of parallel tracks arranged in a horizontal plane and extending in a first direction, and a second set of parallel tracks arranged in the horizontal plane and extending in a second direction which is orthogonal to the first direction, which first and second sets of tracks form a grid pattern in the horizontal plane comprising a plurality of adjacent grid cells, each comprising an access opening defined by a pair of neighboring tracks of the first set of tracks and a pair of neighboring tracks of the second set of tracks; and
a plurality of stacks of storage containers arranged in storage columns located beneath the rail system, wherein each storage column is located vertically below an access opening and wherein the automated storage and retrieval system comprises at least one container handling vehicle of claim 29.

55. A method of lifting a storage container using the container handling vehicle of claim 29, wherein the method comprises:
positioning the container handling vehicle above a stack of storage containers in a storage column, wherein the stack comprises a target storage container;
operating the motor in a first direction to rotate the drive belt and thus the first lifting shaft and the second lifting shaft thereby lowering the lifting frame into contact with an uppermost storage container of the stack;
stopping the motor when the lifting frame is in contact with the uppermost storage container;
connecting the lifting frame to the uppermost storage container;
operating the motor in a second direction, which second direction is opposite the first direction, to rotate the drive belt and thus the first lifting shaft and the second lifting shaft thereby lifting the lifting frame and the connected storage container above the rail system.

56. The method of claim 55, wherein the first lifting shaft and the second lifting shaft rotate in opposite directions.
